(19) United States
(12) Patent Application Publication
(10) Pub. No.: US 2010/0107828 A1
(43) Pub. Date: May 6, 2010

(54) Adjustable Handle System for Fastening Tools That Drive Threaded Fasteners

(76) Inventor: Juan Huerta, Weslaco, TX (US)

Correspondence Address: GUNN, LEE & CAVE, P.C., 300 CONVENT ST., SUITE 1080, SAN ANTONIO, TX, 78205, US

(21) Appl. No.: 12/263,976

(22) Filed: Nov. 3, 2008

(51) Int. Cl. B25B 23/16

(52) U.S. Cl. 81/177.9; 81/177.85; 81/177.2

(57) ABSTRACT

An adjustable handle system for fastening tools that drive threaded fastener into materials. The present invention allows the handle of fastening tools to change shape so that the tool can function in a confined environment. The handle system is made up of at least two handle portions that are interchangeable due to a common form of detachable connection between the handle portions and drive head. The common connections are detachable in that portions of the handle system can be connected and disconnected from each other with minimal effort. Interchangeability of the differently configured portions enables the handle system to take on many different configurations, thus allowing the fastening tool to function in a variety of confined environments.

### CROSS REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to an improved handle system for fastening tools that drive threaded fasteners. More specifically, the invention relates to a handle system that allows multiple configurations of the selected fastening tool so it can drive threaded fasteners in confined environments.

2. Description of the Related Art

Within the field of hand tools, there are a number of tools for driving different types of fasteners into particular materials. These “fastening tools” drive fasteners into a material by exerting a certain type of force at the fastener head. For example, a hammer is a fastening tool that drives nails (i.e., a type of fastener) into wood by striking the nail head and exerting downward force (i.e., force toward the material) on the nail head. Unlike nails, “threaded fasteners” have helical grooves, or “threads,” for driving the fastener into a material. To drive a threaded fastener into material, rotational force must be applied at the fastener head so that the fastener is turned a certain direction and the threads engage the material. Conversely, to extract threaded fasteners from the material, the fastener must be rotated the opposite direction.

Threaded fasteners come in many shapes and sizes. The length of the threaded portion, the width and number of threads on the threaded portion, as well as the circumference of the threaded portion all vary greatly, often depending on the particular material for which the threaded fastener is used. The shape of the thread itself can also differ. Known as the “thread profile,” the shape of threads can be triangular, square, trapezoidal, or other shapes.

Not only do the threaded portion and the threads themselves vary, threaded fastener heads also come in a variety of shapes and sizes. Some threaded fasteners are screws, where the fastener head has a portion cut out for a specific type of fastening tool to be inserted into the fastener head. With screws, the shape of the cutout in the fastener head often dictates the name of the fastening tool used to drive this type of threaded fastener (e.g., “flat-head screwdriver,” “Phillips head screwdriver,” “hex key” or “Allen wrench”). Other types of threaded fasteners are bolts, which have fastener heads manufactured into regular polygons such as hexagons or squares. Bolts are driven into material with wrenches, pliers, or nut drivers. Nut drivers are essentially screwdrivers with a drive head that is configured to receive the polygonal fastener head.

Regardless of the type of threaded fastener, all fastening tools for threaded fasteners have a drive head adapted to apply rotational force, or “torque,” at the fastener head. In this regard, the drive head of the fastening tool must be able to securely grip the fastener head (or a socket) so that the tool will not slip when a user applies force at the handle.

The manner in which the force is applied at the handle of the fastening tool depends on the type of fastening tool being used. For screwdrivers or nut drivers, a user holds the handle of the fastening tool and applies direct rotational force on the handle by bending his/her wrist so that the user's forearm is in line with the handle. Keeping his/her forearm in line with the handle, which acts as the axis of rotation, the user twists his/her forearm. For wrenches, a user grips the handle of the wrench and applies linear force at the handle to turn the fastening tool in a circular path about the fastener head. In this regard, the fastener head is the center point of the circle (i.e., the axis of rotation) and the handle acts as a moment arm that translates the linear force applied at the handle into rotational force at the fastener head. Unlike ordinary screwdrivers or nut drivers, the amount of rotational force at the fastener head is a function of the wrench's handle length. For example, a longer handle enables a greater amount of rotational force with less linear force.

Regardless of whether a screwdriver, nut driver, or wrench is being used, all fastening tools require a certain amount of clearance so that the necessary force can be applied. In ordinary screwdrivers and nut drivers, the handle is vertically aligned with the length of the threaded fastener and the handle extends a certain distance above the fastener head. The “vertical clearance,” which is the available space above the fastener head and opposite the portion of the threaded fastener that goes into the material, must be enough to position the screwdriver or nut driver above the fastener head so that the threaded fastener can be driven as previously described. For wrenches, the main concern is whether adequate “horizontal clearance” is available for the handle of the wrench to move in a circular path about the threaded fastener without being obstructed. Relative to the vertical length of the fastener, the circular path of the handle is usually in a horizontal plane that is perpendicular to the vertical length of the fastener. The “horizontal clearance” is the available space for the handle to travel in its circular path about the fastener head, and, it must be enough to accommodate the handle through its distal end—the end of the handle that is opposite the drive head of the wrench.

The amount of clearance available for the handle can become an issue in confined environments. For example, auto mechanics working on an engine often cannot turn a wrench after it has been positioned on the fastener head because components of the engine interfere with the horizontal movement of the handle in its circular path. In many instances, the horizontal obstructions could be overcome if the handle of the wrench were alterable, so that the handle was not in a straight line. Similarly, a limited amount of vertical clearance above a screw or bolt may prevent the use of ordinary screwdrivers or nut drivers altogether if the handle is too long to fit within the vertical clearance.

To address the problems of inadequate vertical clearance in confined environments, specialized screwdrivers and nut drivers exist. The specialized screwdrivers and nut drivers fall into two categories: (1) those that preserve the normal application of direct rotational force at the handle and (2) those that utilize a wrench-type circular path to provide rotational force at the fastener head. In the first category, the specialized screwdriver or nut driver has a geared bend close to where the fastening tool engages the fastener head and from the bend, the handle extends horizontally, away from the fastener head. Like an ordinary screwdriver or nut driver, the user exerts direct rotational force on the handle, but this rotational force is exerted on a handle that is in a horizontal position relative to the length of the threaded fastener. As a result, the direct rotational force applied on the handle must be translated through the geared bend to exert rotational force at the fastener head. The second category also has a bend, but the bend is not geared. Instead, the user applies linear force at the handle and the fastening tool moves in a circular path about the threaded fastener, just like with a wrench. Also like a wrench, the circular path of the handle must be free from obstruction and the issue of inadequate horizontal clearance arises in confined environments.

To address the problem of confined environments with minimal horizontal clearance, numerous fastening tools and fastening tool accessories are available. Many of these improved fastening tools include dual pivot points allowing the handle of the tool to be bent and thereby avoid obstructions in the horizontal circular path. For example, U.S. Pat. No. 6,382,058 provides a dual-hinged handle so that the handle of the fastening tool can be manipulated to fit within the confined environment. U.S. Pat. No. 7,197,965 also offers the ability to offset the handle at two pivot points. Similarly, U.S. Pat. No. 5,904,077 is a fastening tool accessory with dual pivot points, but does not include a drive head adapted to grip the threaded fastener.

Although the above-mentioned patents do offer some solution to the problems associated with inadequate horizontal clearance, they do not provide a total solution. Significantly, none of these patents offers the ability to alter the location of their pivot points. Thus, the handle length between the pivot points is a constant. Additionally, these fastening tools are limited in that the pivot direction is also fixed. When the fastening tool is engaged with the fastener head, the handle of the tool can only pivot vertically, in a plane aligned with the length of the threaded fastener, as opposed to pivotal movement in the horizontal direction, in a plane perpendicular to the length of the threaded fastener. Because of their limitations, if the confined working environment does not conform to the fixed location and orientations of the pivot points or the handle length between pivot points, a user of these fastening tools can encounter the same horizontal clearance problems that the tools supposedly eliminate.

### BRIEF SUMMARY OF THE INVENTION

The present invention is an adjustable tool handle system that is changeable in shape so that the fastening tool can be utilized in a confined environment (e.g., a car engine). The handle system comprises a drive head having a proximal end configured as a predetermined fastening tool and a distal end having a distal engagement element, a first handle portion detachably connectable to the distal end, and a second handle portion detachably connectable to the first handle portion. A length extension piece may be used to extend the operable length of the system.

The interconnection between the drive head, first handle, and second handle (and when used, length extensions) are made through complimentary proximal and distal engagement elements. According to the preferred embodiment, the proximal engagement elements are male and are engageable with the distal engagement elements. The interconnections between the engagement elements are lockable with ball detents or a similar locking means. Each of the male engagement elements of the preferred embodiment may be pivoted relative to a longitudinal axis such that the angle of the drive head relative to first handle portion may be selectively altered, and so that the angle of the first handle portion relative to the second handle portion may be selectively altered. This selective alteration of angles provides flexibility when working in a confined environment.

### BRIEF DESCRIPTION OF THE DRAWINGS

FIG. 1 illustrates a bottom view of a fastening tool incorporating one embodiment of the handle system of the present invention.

FIG. 2 shows the same embodiment of the handle system of the present invention with a partial cross-sectional view along a plane that bisects the distal end of the handle system.

FIG. 3 is a partial cross-sectional view of another embodiment for the handle system of the present invention, where again, the partial cross-sectional view is along a plane that bisects the distal end of the handle system.

FIG. 4 is a bottom view for an embodiment of the handle system that allows hinged movement of the distal end in a horizontal plane.

FIG. 5 shows a bottom view for an embodiment of the handle system that allows hinged movement of the distal end in a horizontal plane where the length of the handle between the drive head and the pivot point has been changed, as compared with FIG. 4.

FIG. 6 is a perspective view of one embodiment of the drive head that can be used in the present handle system, wherein the distal end of the drive head is female.

FIG. 7 is a perspective view of another embodiment of the drive head that can be used in the present handle system, wherein the distal end of the drive head is male.

FIG. 8 is an exploded perspective view of a dual-hinged embodiment for the handle system of the present invention, wherein axes of horizontal pivotal movement and a drive head with a female distal end are shown.

FIG. 9 is a perspective view of a dual-hinged embodiment for the handle system of the present invention, wherein axes of vertical pivotal movement and a drive head with a male distal end are shown.

FIG. 10 is a perspective view of a dual-hinged embodiment for the handle system of the present invention, wherein the portions of the handle system are pivoted vertically and are configured in an angled relation.

FIG. 11 shows a cross-sectional view of a flex handle and one type of locking means for the handle system of the present invention, wherein the cross-section is along a plane perpendicular to the axis of pivotal movement.

FIG. 12 shows a cross-sectional view of a flex handle and one type of locking means for the handle system of the present invention, wherein the cross-section is along a plane that intersects the length of the axis of pivotal movement.

FIG. 13 is a perspective view of the preferred embodiment for the proximal engagement elements of the present invention.

FIG. 14 shows a cross-sectional view of the preferred flex locking means, which is engaged within and locking a male engagement element in angled relation to a longitudinal axis.

FIG. 15 shows a cross-sectional view of the preferred flex locking means, which is disengaged from the male engagement element.

### DETAILED DESCRIPTION OF THE INVENTION

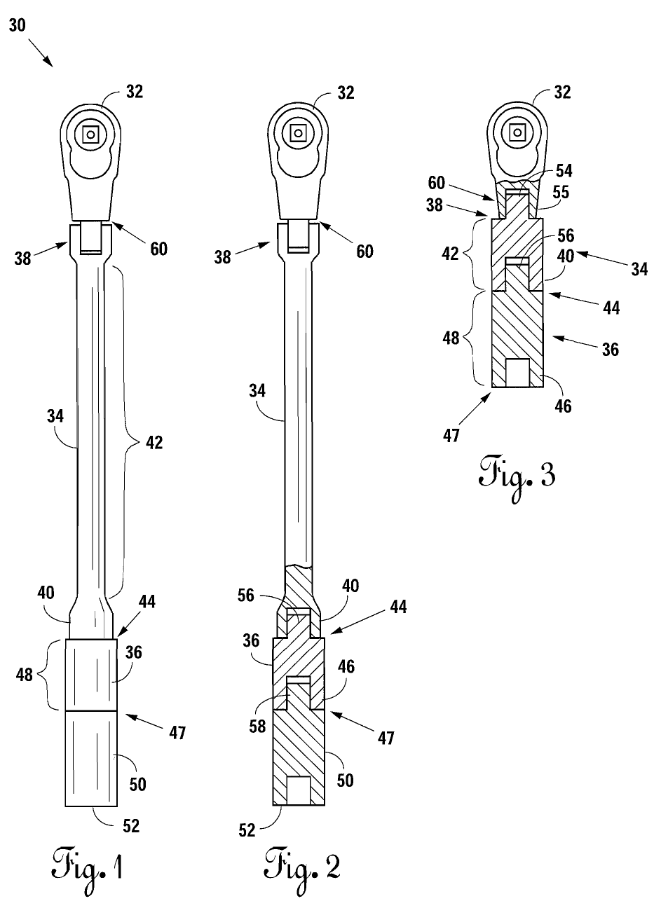

FIG. 1 is a bottom view for one embodiment of the handle system 30 in the present invention. As shown, the handle system 30 has a drive head 32, a first handle portion 34, and a second handle portion 36. As will be recognized through the explanation of other figures, the first handle portion 34 and the second handle portion 36, as well as other parts of the handle system 30, are not defined by the shape shown in FIG. 1, but rather are defined by their position relative to the drive head 32. For example, a “first” part generally means that the part is the first one of its kind, starting from the proximal end of the handle system 30 at the drive head 32 and proceeding toward the distal end of the handle system 30.

In this particular embodiment the first handle portion 34 is long and hinged like a flex handle, as opposed to other embodiments of the handle system 30 where the first handle portion 34 is not as long and is also not hinged. Similarly, the second handle portion 36 in FIG. 1 is short (as compared to the first handle portion 34) and non-hinged; however, in other embodiments of the present invention the second handle portion 36 is longer than the first handle portion 34 and is hinged. Further, the drive head 32 in FIG. 1 has a typical socket wrench configuration; however, the present invention contemplates any type of fastening tool configuration at the proximal end of the drive head 32 that is desired to drive a particular type of threaded fastener, as long as drive head 32 has a distal end 60 that is adapted to connect with other portions of the handle system 30.

The first handle portion 34 has a head-connecting end 38 where the first handle portion 34 connects to the drive head 32 at the distal end 60. In this embodiment, the head-connecting end 38 is male and hinged like a flex handle. Opposite the head-connecting end 38 of the first handle portion 34 is a first distal engagement element 40 and, disposed between the first distal engagement element 40 and the head-connecting end 38 is a first longitudinal axis 42. As it relates to other portions of the handle system 30, the first longitudinal axis 42 is longer in this embodiment; however, the first longitudinal axis 42 is not longer than other portions of the handle system 30 in other embodiments. As shown in FIG. 3 and explained in more detail hereunder, the first longitudinal axis 42 is shorter for the first handle portion 34 in that embodiment. In other words, the first longitudinal axis 42 is any length of material from which the first handle portion 34 is constructed that is between the first distal engagement element 40 and the head-connecting end 38.

FIG. 1 also shows the second handle portion 36, which has a first-handle-connecting end 44, a second distal end 47 that is opposite the first handle connecting end 44, and a second longitudinal axis 48 that is disposed between the second distal end 47 and the first-handle-connecting end 44. The second handle portion 36 is connected to the first handle portion 34 at the first-handle-connecting end 44. As shown in FIG. 1, the second longitudinal axis 48 of the second handle portion 36 is shorter than the first longitudinal axis 42; however, in other embodiments the second longitudinal axis 48 is longer that the first longitudinal axis 42 (see FIG. 8). Similar to the first longitudinal axis 42, the second longitudinal axis 48 is any length of material from which the second handle portion 36 is constructed that is between the first-handle-connecting end 44 and the second distal end 47.

FIG. 1 also shows a length extension 50 connected at the distal end of the handle system 30. Length extension 50 is adapted to connect with the second handle portion 36 at the second distal end 47. Although the length extension 50 is shown as relatively short and non-hinged in FIG. 1, the length extension 50 can be longer and/or hinged in other embodiments. Similar to the first handle portion 34 and the second handle portion 36, the length extension 50 is defined by its position relative to the drive head 32, not by its shape. In the present invention, a length extension is any extension of length that, extending distally from the drive head 32, comes after the second handle portion 36 and is connectable to the second distal end 47. Furthermore, the present invention is not limited to a single length extension 50 as is shown in FIG. 1. In some embodiments, numerous length extensions may be present and connected to each other.

FIGS. 2 and 3 both show a cross section of the handle system 30 to illustrate the common form of the preferred detachable connections between various portions of the handle system 30. The connections are detachable in that portions of the handle system can be connected and disconnected from each other with minimal effort. FIGS. 2 and 3 show the detachable connection between the first handle portion 34 and the second handle portion 36 and show the detachable connection between the second handle portion 36 and the length extension 50. In addition, the cross sectional area of FIG. 3 also illustrates the detachable connection between the head-connecting end 38 of the first handle portion 34 and the distal end 60 of the drive head 32.

As shown in FIG. 3, the head-connecting end 38 of the first handle portion 34 has a first proximal engagement element 54. In this embodiment, the first proximal engagement element 54 is male and is inserted into a distal engagement element 55 that is female and located at the distal end 60 of the drive head 32. As shown in both FIGS. 2 and 3, the first-handle-connecting end 44 of the second handle portion 36 has a second proximal engagement element 56 that is also male and is inserted into the first distal engagement element 40, which is female in this embodiment. The second proximal engagement element 56 of the second handle portion 36 is shaped the same as the first proximal engagement element 54 of the first handle portion 34, so that in practice, the second handle portion 36 could also be inserted into the distal engagement element 55. As such, the second handle portion 36 could be detachably connected to the drive head 32.

In the embodiment shown in FIGS. 2 and 3, the second handle portion 36 has a second distal engagement element 46 at the second distal end 47, which makes the second distal end 47 adapted to connect with a proximal extension engagement element 58 from the length extension 50, as shown in FIG. 2. Although the second handle portion 36 is adapted to connect with the proximal extension engagement element 58 in FIGS. 2 and 3, other embodiments of the second handle portion 36 in the present invention may not have the second distal end 47 adapted to connect with the proximal extension engagement element 58 (see FIG. 8).

It should be noted that, the proximal extension engagement element 58 represents any common proximal engagement element that is present in the handle system 30. As part of the novel components of the present handle system 30, when the proximal extension engagement element 58 is male and the other distal engagement elements are female, the proximal extension engagement element 58 can insert into the second distal engagement element 46, the first distal engagement element 40, and/or the distal engagement element 55. Also shown in FIG. 2, the length extension 50 has a distal extension engagement element 52 that is adapted to connect with proximal extension engagement elements from additional length extensions.

It is significant that all detachable connections shown in FIGS. 2 and 3 are similarly formed. Similarly formed detachable connections between all portions of the handle system 30 are present in the preferred embodiment of the present invention so that all portions of the handle system 30 are interchangeable within the system. Although FIGS. 2 and 3, as well as other figures herein, show the preferred embodiment for detachable connections in the handle system 30, the present invention is not limited to those connections shown. The handle system 30 contemplates any type of connection that will join the different portions of the system.

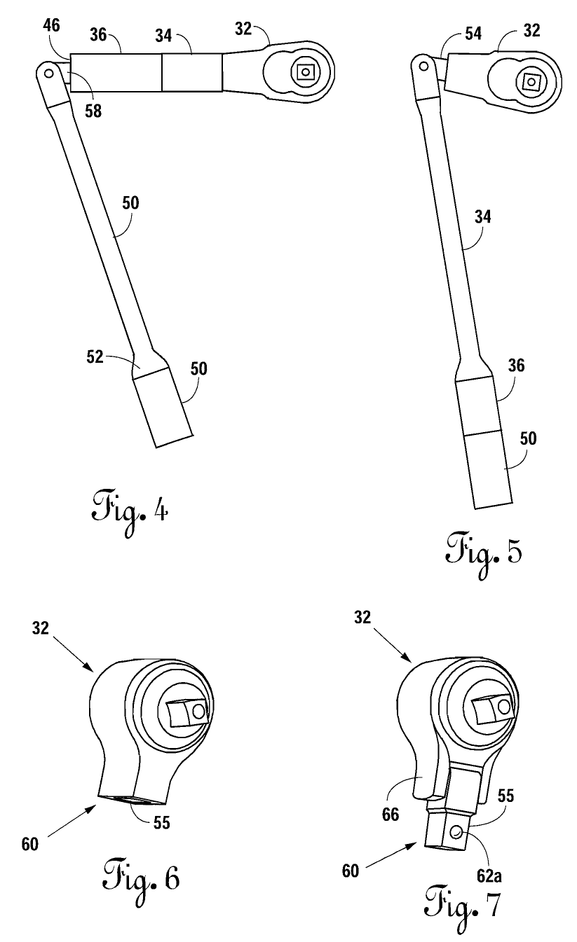

FIGS. 4 and 5 illustrate two similar configurations that can be achieved with the present handle system 30. In FIG. 4, the first handle portion 34 and the second handle portion 36 are not hinged. Instead, the hinged portion in FIG. 4 is the first length extension 50, which is the length extension 50 that is connected to the second handle portion 36 at the second distal engagement element 46 with the proximal extension engagement element 58. A second length extension 50 in FIG. 4 is connected to the first length extension 50 at the distal extension engagement element 52 and is not hinged. In FIG. 5, the first handle portion 34 is the hinged portion in the handle system 30, whereas the second handle portion 36 and the length extension 50 are not hinged.

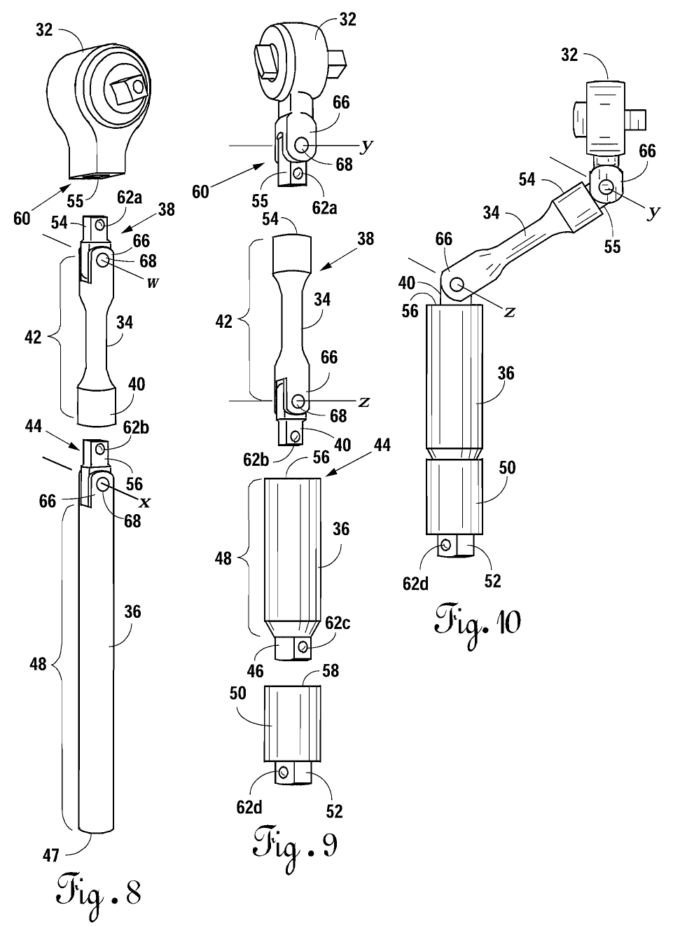

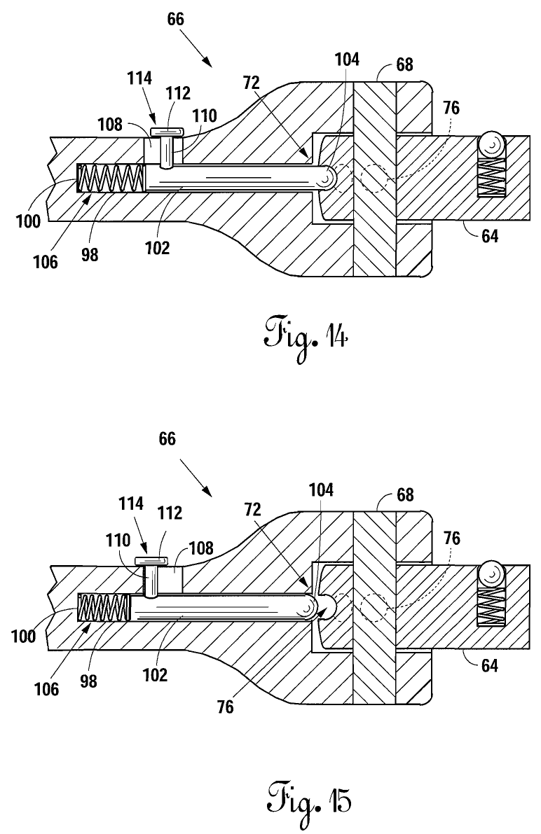

The embodiments shown in FIGS. 4 and 5 are similar in that the hinged portion of the handle system 30 in both embodiments allows pivotal movement in the horizontal direction. In this regard, if the fastening tool at the drive head 32 were engaged with a threaded fastener (not shown), the handle system 30 can pivot in a horizontal plane that is perpendicular to the length of the threaded fastener. In addition, the direction of hinged movement in both FIGS. 4 and 5 can be changed to allow pivotal movement in the vertical direction by simply disconnecting the hinged portion, rotating it ninety degrees about an axis at the center of the connection, and reconnecting it with the respective part of the handle system 30. The ability to change the pivotal direction for portions of the handle system 30 is possible at the majority of connections where the preferred male engagement elements are used (see FIG. 13). However, if the drive head 32 contains the hinge, as shown in FIGS. 7 and 9, the pivotal direction of the first handle portion 34 relative to the drive head 32 cannot be changed. Furthermore, if the male engagement elements are not uniformly shaped, as they are in the preferred male engagement element, changing the pivot direction may not be possible.

FIGS. 6 and 7 show different embodiments of the drive head 32 for the present invention. As shown in FIG. 6, the distal engagement element 55 at the distal end 60 of the drive head 32 is female and is adapted to connect with a male first proximal engagement element 54 of the first handle portion 34 (see FIG. 3), as well as other commonly formed proximal engagement elements. In contrast, the distal engagement element 55 in FIG. 7 is male and is adapted to connect with the first proximal engagement element 54 that is female and/or other commonly formed proximal engagement elements. The distal engagement element 55 in FIG. 7 is pivotally hinged to the drive head 32 with a yoke 66 and a hinge pin (not shown), just as if the drive head 32 were a flex handle. The pivotal hinging of engagement elements is further discussed herein, with reference to FIGS. 11 and 12; however, for purposes of FIG. 7 it is important to note that the distal engagement element 55 that is mounted at the distal end 60 of the drive head 32 does not have to be hinged.

Although the drive head 32 in FIGS. 6 and 7, as well as the other figures, is depicted as a drive head for a ratchet or socket wrench fastening tool, the fastening tool at the drive head 32 may be another type of fastening tool for driving threaded fasteners. For example, the fastening tool at the drive head 32 could be an open-ended wrench or a Crescent® wrench. Additionally, the fastening tool could be a screwdriver tip or a nut driver tip with a bend so that the handle system 30 works as a moment arm, applying rotational force at the fastener head when linear force is applied at the handle. Regardless of the type of fastening tool at the drive head 32, the distal engagement element 55 must be adapted to detachably connect with the first proximal engagement element 54 and other proximal engagement elements in the handle system 30.

FIGS. 8 and 9 show dual-hinged embodiments for the handle system 30 of the present invention. The figures differ in that the distal engagement element 55 and the first distal engagement element 40 in FIG. 8 are female whereas the distal engagement element 55 and the first distal engagement element 40 in FIG. 9 are male. Also, the second distal end 47 in FIG. 8 is not adapted to connect with a length extension 50 whereas is adapted to connect with a length extension 50 in FIG. 9.

In FIG. 8, the first handle portion 34 is a flex handle—a type of handle that is well known to those with ordinary skill in the art. The flex handle is formed by a yoke 66 and a hinge pin 68 at the head-connecting end 38. The yoke 66 and the hinge pin 68 allow the first proximal engagement element 54 to pivot about the w-axis, which allows horizontal pivotal movement of the first handle portion 34 in the orientation shown. The first proximal engagement element 54 is attached at the head-connecting end 38 of the first handle portion 34 and connects with the distal engagement element 55. The first handle portion 34 detachably connects with the drive head 32 when the first proximal engagement element 54 enters into the distal engagement element 55 and the first locking means securely holds the first proximal engagement element 54 in place within the distal engagement element 55. The first locking means shown in this embodiment is a ball detent 62a. Continuing along the first longitudinal axis 42 of the first handle portion 34, the first distal engagement element 40 is female and is adapted to connect with the second proximal engagement element 56 of the second handle portion 36.

The second handle portion 36 of FIG. 8 is also a flex handle with a hinged connection at the first-handle-connecting end 44. The yoke 66 and the hinge pin 68 allow the second proximal engagement element 56 to pivot about the x-axis allows horizontal pivotal movement of the second handle portion 36 in the orientation shown. The second proximal engagement element 56 is at the first-handle-connecting end 44 of the second handle portion 34 and connects with the first distal engagement element 40 of the first handle portion 34. With the same form and function as the connection between the drive head 32 and the first handle portion 34, the second handle portion 36 is adapted to detachably connect with the first handle portion 34 at the first distal engagement element 40. In this embodiment, the second proximal engagement element 56 is male and is inserted into a female first distal engagement element 40. A second locking means holds the second proximal engagement element 56 in place within the first distal engagement element 40. The second locking means in this embodiment is a ball detent 62b. Continuing along the second longitudinal axis 48, the second distal end 47 is not adapted to connect with proximal extension engagement elements 58 of length extensions 50 in this embodiment of the present invention.

FIG. 9 shows the same dual-hinged embodiment as FIG. 8 but the detachable connections between portions of the handle system 30 are opposite those in FIG. 8. To start, the distal engagement element 55 is male and is pivotally hinged to the drive head 32 with yoke 66 and hinge pin 68. As a result, the distal engagement element 55 will pivot about the y-axis, thereby allowing vertical pivotal movement of the first handle portion 34 when the first handle portion 34 is connected. To connect with the male distal engagement element 55, the first proximal engagement element 54 of the first handle portion 34 is female. In further contrast to the embodiment shown in FIG. 8, the first distal engagement element 40 in FIG. 9 is male and is pivotally hinged to the first handle portion 34 with a yoke 66 and a hinge pin 68. In other words, the first handle portion 34 in FIG. 9 is a flex handle at its first distal engagement element 40. As a result, the first distal engagement element 40 will pivot about the z-axis, thereby allowing vertical pivotal movement of the second handle portion 36 when connected.

In FIG. 9, to detachably connect with the first distal engagement element 40 of the first handle portion 34, the second proximal engagement element 56 of the second handle portion 36 is female. Continuing along the second longitudinal axis 48, the second distal engagement element 46 connects with the proximal extension engagement element 58 when the second distal engagement element 46 is inserted into the length extension 50. In this manner, a detachable connection between the second handle portion 36 and the length extension 50 is formed. Further, the distal extension engagement element 52 of the length extension 50 is available for forming detachable connections with additional length extensions.

The detachable connections between portions that are shown in FIG. 9 are the same as those shown in FIG. 8 in that a similar locking means will hold the engagement elements in place once connected. In this regard, the detachable connection between the drive head 32 and the first handle portion 34 in FIG. 9 is formed when the distal engagement element 55 enters into the first proximal engagement element 54 and the first locking means securely holds the distal engagement element 55 in place. In the embodiment in FIG. 9, the first locking means is the ball detent 62a, located on the distal engagement element 55. In addition, the first distal engagement element 40 enters into the second proximal engagement element 56 and a second locking means—which in this embodiment is ball detent 62b—securely holds the first distal engagement element 40 in place. The second distal engagement element 46 also detachably connects with the proximal extension engagement element 58 with a third locking means, which in this embodiment is a ball detent 62c that is located on the second distal engagement element 46. Finally, the distal extension engagement element 52 of the length extension 50 connects with further proximal extension engagement elements on additional length extensions by using the same form of connection and the same locking means as in the previously discussed connections, which in this embodiment is a ball detent 62d.

As described with reference to FIGS. 11-13, the preferred locking means for forming detachable connections between portions of the handle system 30 is a ball detent 62 located within an engagement element 64 that is male. As such, in the preferred embodiment, the ball detent 62 is located on the first proximal engagement element 54, the second proximal engagement element 56, and the proximal extension engagement element 58, as well as additional proximal extension engagement elements. Nonetheless, any locking means can be used that will form a secure detachable connection between the parts, with a secure detachable connection being a connection that is connected and disconnected with minimal effort yet is able to withstand the ordinary forces applied to the handle system 30 when driving (or loosening) a threaded fastener. For example, other types of detents, as well as pins, latches, lock rings, and snap rings or circlips may be used.

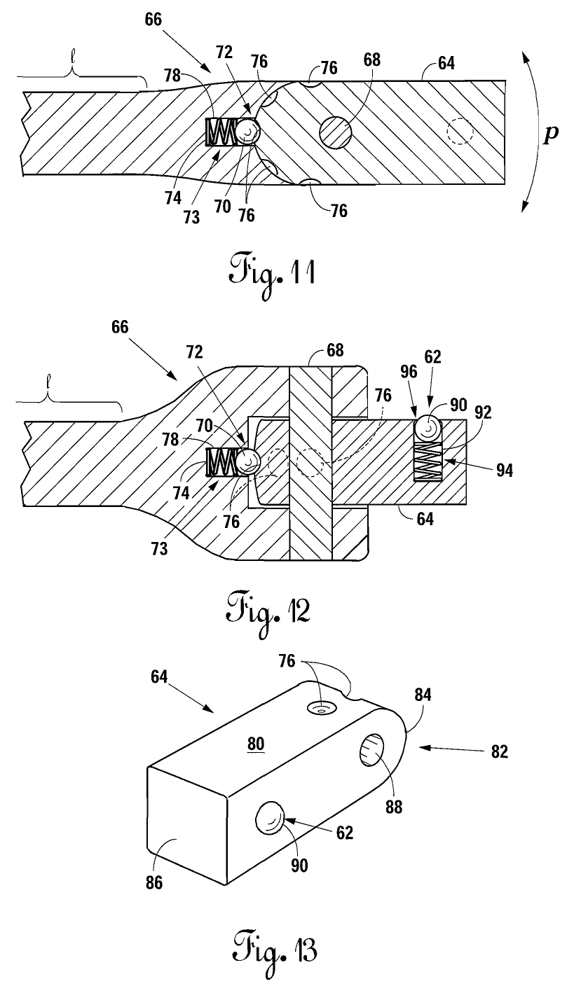

FIG. 10 illustrates one of the handle configurations that is possible with a dual-hinged embodiment of the present handle system 30. FIG. 10 is a fully-connected version of the embodiment shown in FIG. 9, with certain parts of the handle system 30 rotated about a pivot axis. Starting at the drive head 32, the distal engagement element 55 is inserted into a female first proximal engagement element 54 on the first handle portion 34. The distal engagement element 55 is pivoted about the y-axis in the vertical direction, and correspondingly, the first handle portion 34 is also pivoted about the y-axis in the vertical direction. In addition to the detachable connection with the drive head 32, the first handle portion 34 is also detachably connected to the second handle portion 36, where the first distal engagement element 40 of the first handle portion 34 is inserted into a female second proximal engagement element 56. The first distal engagement element 40 and the detachably connected second handle portion 36 are pivoted about the z-axis in the vertical direction. Finally, the length extension 50, which is detachably connected to the second handle portion 36, is effectively pivoted about the z-axis in the vertical direction.

FIGS. 11, 12, and 13 show the preferred embodiment when the first handle portion 34, the second handle portion 36, and/or the length extension 50 is a pivotally hinged flex handle. The description of the parts in these figures could also apply to the distal end 60 of the drive head 32, when the drive head 32 is hinged. Flex handles are well known to those with ordinary skill in the art. As shown, the three main components of a flex handle are the yoke 66, the hinge pin 68, and the engagement element 64. Although shown in male form, it is possible that a flex handle could be formed with a female engagement element. Engagement element 64, yoke 66, and hinge pin 68 represent the flex handle end at any hinged connection in the present handle system 30. In other words, engagement element 64 could be the first proximal engagement element 54, the second proximal engagement element 56, and/or the proximal extension engagement element 58, as well as other proximal engagement elements in the handle system 30. Similarly, engagement element 64 could represent the distal engagement element 55, the first distal engagement element 40, the second distal engagement element 46, as well as the distal extension engagement element 52 and further distal engagement elements in the handle system 30. Thus, reference to certain numbered parts within engagement element 64 (e.g., ball detent 62) applies to any male engagement element in the handle system 30, regardless of whether a hinged connection is formed. Those skilled in the art should recognize whether the presence of a numerically reference part depends on a hinged connection.

Yoke 66 has two forked arms, and disposed between them is hinge pin 68, as shown in FIG. 12. Hinge pin 68 passes through a hinge-pin hole 88 (see FIG. 13) in the engagement element 64 so that the engagement element 64 can pivot about an axis formed by the hinge pin 68. In FIG. 11—which is a cross section of yoke 66 taken along a plane that bifurcates the forked arms of the yoke 66—the pivotal movement of engagement element 64 is shown by pivot line p. The pivotal movement shown by pivot line p allows the engagement element 64 to change its angle with respect to a longitudinal axis l that leads into yoke 66. Longitudinal axis l could represent any longitudinal axis in the handle system 30 when the particular portion is a flex handle, including the first longitudinal axis 42, the second longitudinal axis 48, and longitudinal axes from length extensions 50. In FIG. 11, the angled relation between engagement element 64 and longitudinal axis l is zero degrees. The angled relation between the engagement element 64 and longitudinal axis l changes as the engagement element 64 is pivoted about the hinge pin 68 along pivot line p.

To resist pivotal movement of the engagement element 64, a flex locking means securely holds the engagement element 64 in angled relation to longitudinal axis 1. The flex locking means for the embodiment shown in FIGS. 11 and 12 is a ball detent 73. The ball detent 73 is formed by a rigid ball 70 biased against an opening 72 in yoke 66 by a spring 74 that is located in a bore 78. The ball 70 partially extends from the opening 72 and enters into an individual depression 76 in the engagement element 64. When the ball 70 is seated within the individual depression 76, the engagement element 64 is locked in angled relation to the longitudinal axis 1. To pivot engagement element 64 about the hinge pin 68 (thereby changing the angled relation of engagement element 64 to longitudinal axis 1), the force of spring 74 must be overcome so that ball 70 retracts into the bore 78. With ball 70 retracted into the bore 78, the ball 70 no longer partially extends from the opening 72 into the individual depression 76 and engagement element 64 can pivot.

FIG. 13 shows the preferred male embodiment for engagement element 64. Engagement element 64 is formed by a stud 80 that is located adjacent a substantially-arced portion 82, with the hinge-pin hole 88 there-between. The substantially-arced portion 82 has an apex 84 located at the midpoint of the substantially-arced portion 82. The stud 80 has a proximal end 86 that is substantially square in shape. The proximal end 86 of the stud 80 faces the opposite direction of the apex 84 of the substantially-arced portion 82. Located on the substantially-arced portion 82 are the individual depressions 76 into which the ball 70 or a locking rod 102 (see FIGS. 14 and 15) enters. The individual depressions 76 in the preferred engagement element 64 are in a semicircular path around the substantially-arced portion 82, with the semicircular path being transverse to the hinge-pin hole 88 in the engagement element 64.

Ball detent 62, the preferred locking means for forming detachable connections between portions of the handle system 30, is also shown in FIGS. 12 and 13. Ball detent 62 is representative of ball detents 62a-62d and is formed by a locking ball 90, a bore 92 disposed within the engagement element 64, and a spring 94 within the bore 92. The spring 94 biases the locking ball 90 against an opening 96 in the engagement element 64. The opening 96 in the engagement element 64 is small enough to keep the majority of locking ball 90 within the bore 92. The portion of the locking ball 90 that protrudes from the opening 96 will enter into a depression in female engagement elements (not shown). The protruding part of the locking ball 90 holds the engagement element 64 within female engagement elements, and, the biasing force of the spring 94 against the locking ball 90 must be overcome to remove the engagement element 64 from a female engagement element.

It should be noted that the preferred female embodiment of the engagement element 64 can be formed from the same elements shown in FIG. 13, except that stud 80 would have a proximal end 86 that is female and ball detent 62 would not be present. Rather, the ball detent 62 would be present on the corresponding male engagement element. Nonetheless, a pivotally hinged female engagement element is possible in the present invention.

The preferred flex locking means shown in FIGS. 14 and 15 is superior to the ball detent 73 flex locking means previously described. With the preferred flex locking means, the individual depressions 76 in the substantially-arced portion 82 can be deeper into the engagement element 64. The locking rod 102 is capable of fully sliding into these deeper individual depressions 76 so that the depression is completely filled. In contrast, only about one half of the ball 70 from the ball detent 73 flex locking means (see FIGS. 11 and 12) can enter into the individual depressions 76, regardless of the depth of the depression. With only half of the ball 70 in the individual depression 76, only the force of spring 74 must be overcome to push the ball 70 back into the bore 78 so that the engagement element 64 can be pivoted. The forces exerted on the handle system 30 to apply rotational force at the fastener head are often too great and the force of the spring 74 in the ball detent 73 flex locking means could be overcome. To address this problem, a front portion 104 of the locking rod 102, which may or may not be rounded, must be moved from the individual depression 76 by the user, giving the user more control and providing a more stable lock.

The preferred flex locking means is intended for any portions of the handle system 30 that are lockable flex handles. The preferred flex locking means starts with a longitudinal bore 98 disposed within the longitudinal axis l (see FIGS. 11 and 12). The longitudinal bore 98 starts at a base 100 in longitudinal axis l, extends toward the engagement element 64, and ends at the opening 72 in the yoke 66. Slideably situated within the longitudinal bore 98 is the locking rod 102 with the front portion 104 that is capable of sliding into the individual depressions 76 in the engagement element 64. Between the locking rod 102 and the base 100 is a biasing means for biasing the locking rod 102 toward the engagement element 64 and into the individual depressions 76 on the engagement element 64. The biasing means in the embodiment shown is a spring 106, but can be any equivalent biasing means known in the art.

Connected to the locking rod 102 is a connector arm 110. The connector arm 110 extends through a slotted opening 108 in the longitudinal axis l to the external surface of the longitudinal axis l. The connector arm 110 is any shape that is capable of connecting with the locking rod 102 through the slotted opening 108, as long as the locking rod 102 will be moved against the biasing means when the connecting arm 110 is moved in that direction. As shown, the connector arm 110 of the preferred flex locking means has a switch 112 mounted thereon. The switch 112 has an upper surface 114 on which a user of the preferred flex locking means can exert a force with his/her thumb and effectively move the front portion 104 of the locking rod 102 out of an individual depression 76, vis-à-vis the connector arm 110.

I claim:

1. An adjustable handle system comprising:
a drive head having a proximal end adapted as a predetermined type of fastening tool and a distal end having a distal engagement element;
a first handle portion detachably connectable to said distal end, said first handle portion comprising:
a head-connecting end having a first proximal engagement element;
a first distal engagement element adapted to connect with a proximal engagement element; and
a first longitudinal axis disposed between said head-connecting end and said first distal engagement element;
a second handle portion detachably connectable to said first handle portion, said second handle portion comprising:
a first-handle-connecting end having a second proximal engagement element;
a second distal end; and
a second longitudinal axis disposed between said first-handle-connecting end and said second distal end;
a first locking means for forming a detachable connection between said first proximal engagement element and said drive head; and
a second locking means for forming a detachable connection between said first distal engagement element and said second proximal engagement element.

2. The adjustable handle system of claim 1 wherein said proximal engagement elements are male.

3. The adjustable handle system of claim 1 wherein said distal engagement elements are male.

4. The adjustable handle system of claim 1 wherein all interconnections are commonly formed so that all portions of the handle system are interchangeable.

5. The adjustable handle system of claim 1 further comprising:
a second distal engagement element adapted to connect with a proximal engagement element at said second distal end;
at least one length extension detachably connectable to said second handle portion, said at least one length extension having a proximal extension engagement element and a distal extension engagement element adapted to connect with a proximal engagement element; and
a third locking means for forming a detachable connection between said second distal engagement element and said proximal extension engagement element.

6. The adjustable handle system of claim 5 wherein all interconnections are commonly formed so that all portions of the handle system are interchangeable.

7. The adjustable handle system of claim 1 wherein said first handle portion is a flex handle which further comprises a first yoke pivotally coupled to said first proximal engagement element with a hinge pin.

8. The adjustable handle system of claim 7 wherein said first proximal engagement element comprises:
a substantially rectangular end; and
a substantially-arced end having an apex.

9. The adjustable handle system of claim 8 wherein said first handle portion further comprises a first flex locking means for locking said first proximal engagement element in angled relation to said first longitudinal axis.

10. The adjustable handle system of claim 9 wherein:
said substantially-arced end comprises a plurality of depressions aligned transverse to the pivotal axis of said first proximal engagement element; and
said first flex locking means comprises:
a longitudinal bore disposed parallel to said first longitudinal axis, said longitudinal bore beginning at a base and extending toward the head-connecting end of said first handle portion and ending at an opening in said first yoke;
a locking rod slidably situated within said longitudinal bore and extendable past said opening in said first yoke, said locking rod having a front portion engageable with said plurality of depressions;
a biasing means for urging said locking rod away from said base, said biasing means interposed between said base and said locking rod;
a slotted opening disposed between said longitudinal bore and the external surface of said first longitudinal axis; and
a connector arm attached to said locking rod and extending through said slotted opening to the external surface.

11. The adjustable handle system of claim 10 wherein said biasing means is a spring.

12. The adjustable handle system of claim 9 wherein:
said substantially-arced end comprises a plurality of depressions aligned transverse to the pivotal axis of said first proximal engagement element; and
said first flex locking means comprises a ball detent protruding from an opening in said first yoke, said ball detent engagable with said plurality of depressions to lock the angled relationship between said first proximal engagement element and said first longitudinal axis.

13. The adjustable handle system of claims 1 or 5 wherein said second handle portion is a flex handle which further comprises a yoke pivotally coupled to said second proximal engagement element with a hinge pin.

14. The adjustable handle system of claim 13 wherein said second proximal engagement element comprises:
a substantially rectangular end; and
a substantially-arced end having an apex.

15. The adjustable handle system of claim 14 wherein said second handle portion further comprises a second flex locking means for locking said second proximal engagement element in angled relation to said second longitudinal axis.

16. The adjustable handle system of claim 15 wherein:
said substantially-arced end comprises a plurality of depressions aligned transverse to the pivotal axis of said second proximal engagement element; and
said second flex locking means comprises:
a longitudinal bore disposed parallel to second longitudinal axis, said longitudinal bore beginning at a base and extending toward the first-handle-connecting end of said second handle portion and ending at an opening in said second yoke;
a locking rod slidably situated within said longitudinal bore and extendable past said opening in said second yoke, said locking rod having a front portion engageable with said plurality of depressions;
a biasing means for urging said locking rod away from said base, said biasing means interposed between said base and said locking rod;
a slotted opening disposed between said longitudinal bore and the external surface of said second longitudinal axis; and
a connector arm attached to said locking rod and extending through said slotted opening to the external surface.

17. The adjustable handle system of claim 16 wherein said biasing means is a spring.

18. The adjustable handle system of claim 15 wherein:
said substantially-arced end comprises a plurality of depressions aligned transverse to the pivotal axis of said first proximal engagement element; and
said second flex locking means comprises a ball detent protruding from an opening in said second yoke, said ball detent engagable with said plurality of depressions to lock the angled relationship between said second proximal engagement element and said second longitudinal axis.

19. The adjustable handle system of claim 7 wherein said second handle portion is a flex handle which further comprises a second yoke pivotally coupled to said second proximal engagement element with a hinge pin.

20. The adjustable handle system of claim 9 wherein said second handle portion is a flex handle which further comprises a second yoke pivotally coupled to said second proximal engagement element with a hinge pin and wherein said second proximal engagement element comprises:
a substantially rectangular end; and
a substantially-arced end having an apex.

21. The adjustable handle system of claim 20 wherein said second handle portion further comprises a second flex locking means for locking said second proximal engagement element in angled relation to said second longitudinal axis.

22. The adjustable handle system of claim 21 wherein:
said substantially-arced ends of said first proximal engagement element and said second proximal engagement element each comprise a plurality of depressions aligned transverse to the pivotal axes of said first and second proximal engagement elements, respectively;
said first flex locking means for said first handle portion comprises:
a longitudinal bore disposed parallel to said first longitudinal axis, said longitudinal bore beginning at a base and extending toward the head-connecting end of said first handle portion and ending at an opening in said first yoke;
a locking rod slidably situated within said longitudinal bore and extendable past said opening in said first yoke, said locking rod having a front portion engageable with said plurality of depressions;
a biasing means for urging said locking rod away from said base, said biasing means interposed between said base and said locking rod;
a slotted opening disposed between said longitudinal bore and the external surface of said first longitudinal axis; and
a connector arm attached to said locking rod and extending through said slotted opening to the external surface; and
said second flex locking means for said second handle portion comprises:
a longitudinal bore disposed parallel to second longitudinal axis, said longitudinal bore beginning at a base and extending toward the first-handle-connecting end of said second handle portion and ending at an opening in said second yoke;
a locking rod slidably situated within said longitudinal bore and extendable past said opening in said second yoke, said locking rod having a front portion engageable with said plurality of depressions;
a biasing means for urging said locking rod away from said base, said biasing means interposed between said base and said locking rod;
a slotted opening disposed between said longitudinal bore and the external surface of said second longitudinal axis; and
a connector arm attached to said locking rod and extending through said slotted opening to the external surface.

23. The adjustable handle system of claim 22 wherein said biasing means of said first and second flex locking means are springs.

24. The adjustable handle system of claim 21 wherein:
said substantially-arced end of said first proximal engagement element comprises a plurality of depressions aligned transverse to the pivotal axis of said first proximal engagement element; and
said first flex locking means comprises a ball detent protruding from an opening in said first yoke and engagable with said plurality of depressions to lock the angled relationship between said first proximal engagement element and said first longitudinal axis;
said substantially-arced end of said second proximal engagement element comprises a plurality of depressions aligned transverse to the pivotal axis of said second proximal engagement element; and
said second flex locking means comprises a ball detent protruding from an opening in said second yoke and engagable with said plurality of depressions to lock the angled relationship between said second proximal engagement element and said second longitudinal axis.
